(19) United States
(12) Patent Application Publication
(10) Pub. No.: US 2006/0288292 A1
(43) Pub. Date: Dec. 21, 2006

(54) SYSTEM AND METHOD FOR DISPLAYING INFORMATION OF A MEDIA PLAYING DEVICE ON A DISPLAY DEVICE

(76) Inventors: Kuan-Hong Hsieh, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,735

(22) Filed: Apr. 27, 2006

(30) Foreign Application Priority Data
Jun. 17, 2005 (CN) 200510035415.3

(51) Int. Cl. G10H 7/00

(52) U.S. Cl. 715/727; 84/645

(57) ABSTRACT

A system and a method for displaying the information of a media playing device on a display device are provided. The system includes a media playing device and a display device. The media playing device includes an interface for outputting the information thereof. The display device is connected to the media playing device via a data link, obtains and displays the information from the interface of the media playing device.

### TECHNICAL FIELD

The present invention relates to a systems and methods for displaying information of a media playing device, more specifically, to a system and method of a media playing device that can input and output information through a display device.

### GENERAL BACKGROUND

Advantages of portable media playing devices such as its small size, low energy consumption, and so on, have made it a popular choice amongst consumers. It can be used in a wide range of applications and its features are constantly developed to include colorful graphical interfaces, lyrics displays, and the like.

Yet, the small, tiny, slim characteristics of a portable media playing device have put a constraint on the size of the display screen. The size of the display screen has limited the viewing distant of a user on the display screen, furthermore it would also cause a user's eyes to tire easily.

Additionally, cost constraints on the media playing device have limited the colors and resolution of the display screen, making the display screen unable to display specified detailed information.

Furthermore, the conventional operation method of a media control device through a key-press, touch screen, touchpad, and the like on such a small gadget makes it very inconvenient to use. This is because not only does a user have to operate the small media playing device through even smaller controls, but also has to have a strong focus on any control information displayed on the tiny display screen.

The development on display technologies has had great improvement on color and resolutions on easily accessible display devices such as a family TV set. Therefore, developing a communication link between the media playing device and an easily accessible display unit will give consumers an addition display option with no additional costs.

### SUMMARY

A system for displaying the information of a media playing device on a display device is provided. The system includes a display device and a media playing device connected by a data link wherein the display device obtains and displays information from the media playing device.

A method for displaying the information of the media playing device on the display device is also provided. The method includes the steps of: (a) the display device receives a mode control command from a control device, the Micro-Control Unit (MCU) of the display device executes an internal control process to control corresponding operations; (b) the display device switches into a music mode, when the display device receive a mode control command; (c) the display device displays the information of an interactive menu interface from the media playing device; (d) in the music mode, the display device transmits an interactive menu control command from the control device to the media playing device; (e) In response to the interactive menu control command, the media playing device reads the corresponding information and sends the information to the display device; and (f) the display device obtains and displays the corresponding information from the media playing device when the media playing device is connected to the display device.

A media playing device is further provided. The media playing device includes: a data storage medium for storing information, the information comprising audio information and video information; an interface for outputting the video information to the display device; the interface consist of a VGA interface, a DVI interface or other interface; a display processing unit for processing the video information from the data storage medium or the other external electronic device; an audio processing unit for processing the audio information from the data storage medium or the other external electronic device; a MCU for controlling the media playing device to execute corresponding operations, and output the information to the display device.

The advantage of the present invention is that connects a media playing device and a display device, sending the information of the media playing device to the display device, and displaying the information on the display device, in this way, the user can watch the information fairly and expediently on the display screen of the display device in the distance.

### BRIEF DESCRIPTION OF DRAWINGS

FIG. 1 is a block diagram of a system for displaying information from a media playing device on a display device in accordance with a preferred embodiment of the present invention; and

FIG. 2 is a flow chart of a preferred method for implementing the system of FIG. 1.

### DETAILED DESCRIPTION

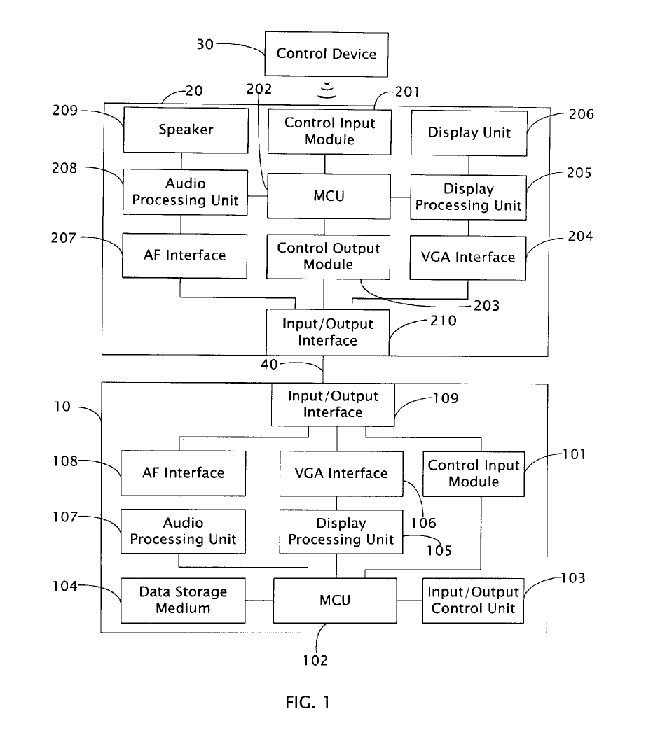

FIG. 1 is a block diagram of a system for displaying information from a media playing device on a display device in accordance with a preferred embodiment of the present invention. The system mainly includes a media playing device 10, a display device 20 connected to the media playing device 10 via a data link 40, and a control device 30. The control device 30 is used to input commands to the display device 20. The input commands can be a mode control command, an interactive menu control command, and so on. The media playing device 10 is capable of playing information stored thereof, and transmitting data information to the display device 20 connected thereto. Upon receiving the data information from the media playing device 10 and the mode control command from the control device 30, the display device 20 switches to a music mode and plays the information thereon. In music mode, the display device 20 further displays an interactive menu interface for a user to select desired data information to be executed by the media playing device 10. The media playing device 10 would send the executed data information through the data link 40 and outputted by the display device. In other words, the display device 20 would output data information corresponding to input commands of the media playing device 10 interactive menu interface that is displayed on the display device 20.

The display device 20 may consist of a cathode ray tube (CRT) monitor, a liquid crystal display (LCD), a CRT TV set, a liquid crystal TV set or other display devices. For simplicity, the preferred embodiment of the present invention employs a CRT TV set as the display device, but it should be noted that the present invention should not be constructed as limited to the embodiment sets forth herein. The display device 20 mainly includes a control input module 201, a MCU 202, an control output module 203 which may be an emitter, a VGA interface 204, a display processing unit 205, a display unit 206, an AF interface 207, an audio processing unit 208, one or more speakers 209, and an input/output interface 210. The input/output interface 210 is a port with means for data transmission of the control output module 203, the VGA interface 204 and the AF interface 207. The control input module 201 receives and processes the control inputs from the control device 30, and transmits the processed control inputs to the MCU 202 to execute a corresponding operation. For example, when the control input module 201 receives a processed mode control command, the MCU 202 executes an internal control process to switch into a music mode according to the processed mode control command. That is, When the MCU 202 executes a command to switch to music mode, the display processing unit and the audio processing unit executes data respectively at the VGA Interface 204 and the AF Interface 207 that are received via the data link 40 from the media playing device. The display processing unit and the audio processing unit then outputs the data through the display unit and the speaker(s) respectively; When the control input module 201 receive an interactive menu control command, the MCU 202 commands the display processing unit 205 to receive and display the corresponding information, and switch the display device to a music mode. Simultaneously, while executing the interactive menu interface, the MCU 202 transmits relevant data to the media playing device via the control output module 203.

The media playing device 10 consists of a control input module 101, a MCU 102, an input/output control unit 103, a data storage medium 104, a display processing unit 105, a VGA (Video Graphics Array) interface 106, an audio processing unit 107, and an AF (Audio Frequency) interface 108, an input/output interface 109. The input/output interface 109 is a port with means for data transmission of the control input interface 101, the VGA interface 106 and the AF interface 108. The data storage medium 104 is used for storing data files for to be executed. The data files include songs, videos, menu interfaces, and so on. Furthermore, the data files can be grouped into audio data and video data. The input/output control unit 103 provides a data connection port for inputting or outputting data from an external electronic device, thereby providing the data that may be stored in the data storage medium 104. The input/output control unit 103 may be a network interface, a USB interface, or the other type of interfaces. The control input module 101 receives and processes the interactive menu control command from the control output device 203 of the display device 20, and sends the processed interactive menu control command to MUC 102. The MCU 102 obtains the corresponding information from the input/output control unit 103 or the data storage medium 104 in response to the interactive menu control command, and controls the display processing unit 105 and the audio processing unit 107 to process corresponding information. For example, the display processing unit 105 sends the video information to the VGA interface 204 of the display device 20 via the VGA interface 106, and the audio processing unit 107 sends the audio information to the AF interface 207 of the display device 20 via the AF interface 108. Accordingly, the display processing unit 205 displays the video information from the VGA interface 204 on the display unit 206, simultaneously, the audio processing unit 208 outputs the audio information to the speaker 209 to play out.

In addition, in the other embodiments according to the present invention, the VGA interface 106 of the media playing device 10 and the VGA interface 204 the of display device 20 can be replaced by a DVI (Digital vision interface) interface.

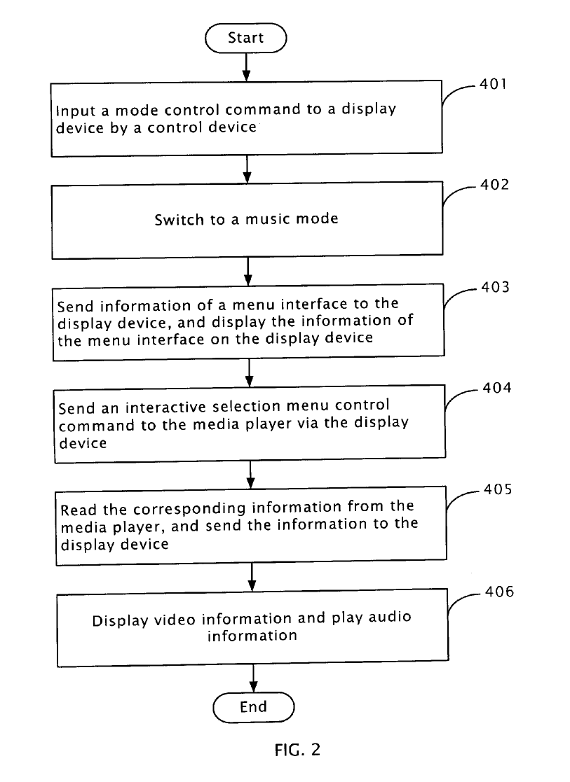

FIG. 2 is a flow chart of a preferred method for implementing the system of FIG. 1. In step 401, the display device 20 receives a mode control command from the control device 30. In step 402, the display device switches into a music mode. In step 403, the display device 20 displays the information of the interactive menu interface from the media playing device 10. In step 404, the display device transmits an interactive menu control command from the control device 30 to the media playing device 10. In step 405, in response to the interactive menu control command, the media playing device 10 reads the corresponding information from the data storage medium 104 or other electronic devices and transmits the information to the display device 20. In step 406, the display device 20 receives the information, displays the video information on the display unit 206, and plays the audio information through the speakers 209.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A system for displaying, the system comprising a media playing device and a display device, wherein:
the media playing device comprises an interface for outputting information to be displayed on the display device; and
the display device is connected to the media playing device via a data link, obtaining and displaying the information outputted from the interface of the media playing device.

2. The system as claimed in claim 1, further comprising a control device for sending a mode control command and an interactive menu control command to the display device.

3. The system as claimed in claim 2, wherein the display device switches to a music mode, when receiving the mode control command.

4. The system as claimed in claim 2, wherein the display device further comprises a control output module for transmitting an interactive menu control command to the media playing device.

5. The system as claimed in claim 4, wherein the media playing device further comprises a control input module for receiving an interactive menu control command from the control output module of the display device.

6. The system as claimed in claim 1, wherein the interface is a Video Graphics Array (VGA) interface.

7. The system as claimed in claim 1, wherein the interface is a Digital Vision interface (DVI) interface.

8. The system as claimed in claim 1, wherein the data link transmits video information and audio information.

9. A method for displaying information from a media playing device on a display device, the method comprising the steps of:
inputting a mode control command to the display device by a control device;
switching the display device to a music mode;
transmitting information of a menu interface from the media playing device to the display device and displaying the information thereon;
inputting an interactive menu control command by the control device to the media playing device via the display device;
executing the corresponding information from the media playing device in response to the interactive menu control command, and transmitting the information to the display device; and
receiving and displaying the information on the display device.

10. A media playing device connected to an external display device, the media playing device comprising:
a data storage medium for storing information, the information comprising audio information and video information;
an interface for outputting video information to the display device;
a display processing unit for processing the video information from the data storage medium;
an audio processing unit for processing the audio information from the data storage medium;
a MCU for controlling the media playing device to execute corresponding operations, and output the information to the display device.

11. The media playing device as claimed in claim 10, further comprising an input/output control unit for obtaining information from an external electronic device.

12. The media playing device as claimed in claim 10, further comprising a control input module for receiving an interactive menu control command from the control device via the display device.

13. The media playing device as claimed in claim 10, wherein the interface is a video interface.
